(19) United States
(12) Patent Application Publication
(10) Pub. No.: US 2003/0188467 A1
(43) Pub. Date: Oct. 9, 2003

(54) Method and apparatus for identifying keys

(76) Inventor: Thomas E. Truelsen, Johnston, IA (US)

Correspondence Address: STURM & FIX LLP, 206 SIXTH AVENUE, SUITE 1213, DES MOINES, IA, 50309-4076, US

(21) Appl. No.: 10/119,119

(22) Filed: Apr. 9, 2002

(51) Int. Cl. G09F 3/00

(52) U.S. Cl. 40/330; 40/595

(57) ABSTRACT

A method of using an apparatus for identifying keys of a type that has a plurality of tags with adhesive on one side thereof for permitting attachment to a key. The tags are distinguishable from each other by a combination of color and shape. A reference sheet is also provided which has a plurality of indicia thereon, each respective indicia being of a color and shape to match the color and shape of the tags. The reference sheet has a space beside each one of the colored indicia for permitting an identification of an object to be placed in this respective space. This permits the respective colored indicia to be matched to a respective tag attached to a key thereby matching the key with the object to be locked or unlocked.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to a method and apparatus for identifying keys and more particularly to such an apparatus which has a plurality of tags identifiable by a combination of color and shape which match indicia on a reference sheet having a description of the object which can be unlocked by such key.

2. Description of Prior Art

People often have keys for unlocking objects and the person with the keys has forgotten which key matches with the object to be locked or unlocked. Unless all of the keys that are in a person's possession are labeled, there is a danger that if the key is not used on a regular basis, the owner will not be able to quickly identify which key is matched with which object, such as a house, automobile, padlock, etc.

It is apparent from looking at the patented prior art that this problem is a long standing one. For example, U.S. Pat. No. 312,545 was patented in 1885 and discloses the problem and the solution being to have a detachable name plate on each key.

U.S. Pat. No. 1,485,075 issued to Gumar in 1924 is another instance of someone trying to solve this old problem.

In 1949, U.S. Pat. No. 2,485,051 to Joslyn shows a system for storing keys in a device having labels thereon so that the key can always be matched up with the object to which it is associated if the keys are in fact stored in the disclosed key case as proposed.

Solutions to the problem were still being devised in 1961 when U.S. Pat. No. 2,982,042 was granted to Mr. Jay Kent. And just a few years later, in 1967, U.S. Pat. No. 3,324,586 to Mitchell was patented and shows a system for labeling keys.

In 1979, U.S. Pat. No. 4,133,195 was issued to McLaren. This patent uses a key ring having colored and numbered blocks wherein a key can be attached to each block and information about the number and color can be recorded on a master board and a code book programmed by color and number to identify particular key-lock combinations.

U.S. Pat. No. 4,907,359 to Berman was issued in 1990 and also provides a system for identifying keys.

Accordingly, it can be seen that while this problem has been recognized for at least the last century, people do not seem to be happy with the solutions available and continue to devise various solutions to the problem. Accordingly, there is a need for a method and apparatus for identifying keys which is so simple, inexpensive and easy to use that it will render further development in this area to be unnecessary.

### BRIEF SUMMARY OF THE INVENTION

The present invention relates to a method of using an apparatus for identifying keys of a type that has a plurality of tags with adhesive on one side thereof for permitting attachment to a key. The tags are distinguishable from each other by a combination of color and shape. A reference sheet is also provided which has a plurality of indicia thereon, each respective indicia being of a color and shape to match the color and shape of the tags. The reference sheet has a space beside each one of the colored indicia for permitting an identification to be placed in this respective space. This permits the respective colored shape to be matched to a respective tag attached to a key, thereby matching the key with the object to be locked or unlocked.

To use this apparatus, a first tag is placed on a head of a first key and the name of the object to be unlocked by the first key is placed on the reference sheet adjacent to indicia matching the shape and color of the first tag. A second tag then is placed on a head of a second key. Then the name of the second object, which can be unlocked using the second key, is placed on the reference sheet adjacent to an indicia matching the shape and color of the second tag. This process is then repeated with a third tag on a third key, etc. until all keys have been matched up with the respective object which they can lock or unlock. Dates can be placed on the reference sheet at the time that the respective keys are labeled if desired.

An object of the present invention is to provide an improved method and apparatus for identifying keys.

Another object of the present invention is to provide an apparatus for identifying keys which is simple to use.

A still further object of the present invention is to provide an apparatus for identifying keys which is economical to manufacture.

A still further object of the present invention is to provide an apparatus for identifying keys which is extremely compact.

Other objects, advantages, and novel features of the present invention will become apparent from the following detailed description of the invention when considered in conjunction with the accompanying drawings.

### BRIEF DESCRIPTION OF THE DRAWINGS

FIG. 1 is a perspective view of two keys on a key ring and showing in dashed lines, a person in readiness to use one of the keys;

FIG. 2 is an instruction sheet which accompanies the key identification apparatus of FIGS. 3-9;

FIG. 3 is a tag sheet which has colored tags at the top thereof, the tags having adhesive on the backside thereof and which tags are distinguishable from each other by combinations of shape and color in each row, and having a plurality of labels on the tag sheet which also have adhesive on the back thereof and can be removed and placed on a reference sheet;

FIG. 4 is a reference sheet having a plurality of indicia codes thereon which are distinguishable from each other by a combination of shape and color and which can be matched to the tags of FIG. 3;

FIG. 5 is a reference sheet, like the one shown in FIG. 4, but it is small enough to be placed in a wallet, shirt pocket or purse;

FIG. 6 illustrates how the tags can be removed from the tag sheet;

FIG. 7 illustrates how the tags can be placed on the head of a key;

FIG. 8 shows how the labels can be removed from the tag sheet; and

FIG. 9 shows how the labels can be placed on a reference sheet.

### BEST MODE FOR CARRYING OUT THE INVENTION

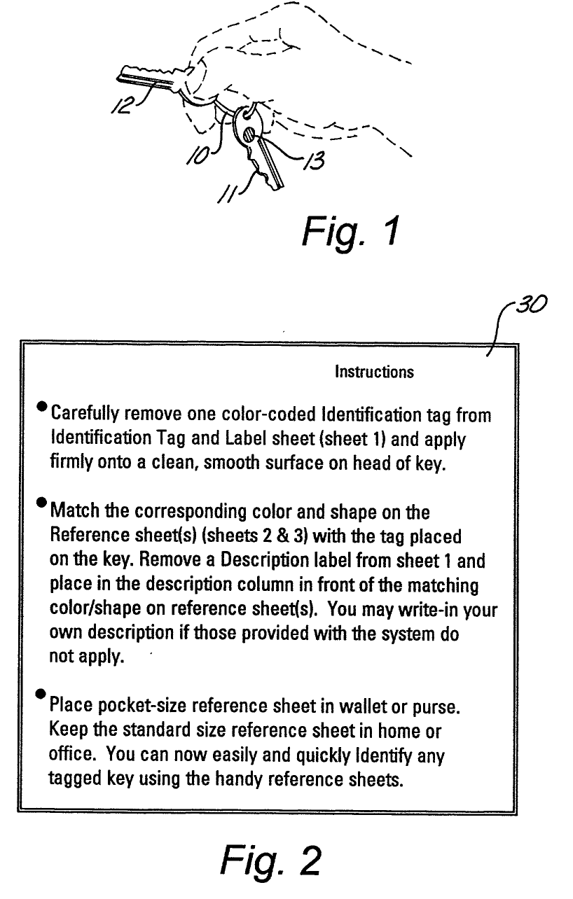

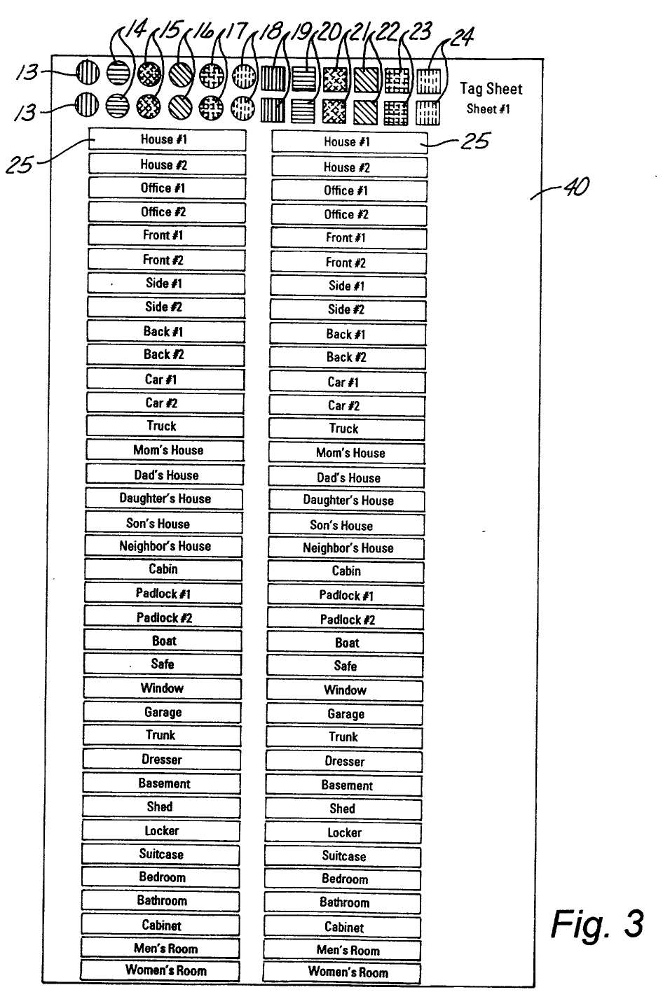

Referring now to the drawings wherein like reference numerals designate identical or corresponding parts throughout the several views, FIG. 1 shows a key chain (10) having a first key (11) and a second key (12) thereon. The key (11) has a tag (13) thereon which is circular and red for reasons which will be explained below. Referring to FIG. 3, a tag sheet (20) has a plurality of tags like the red tag (13) attached with adhesive to the top thereof. It is preferred that these tags (13)-(24) are constructed of the same type of reflective material that are used to attach renewal tags to vehicle license plates such as when the license plate is renewed from year to year by placing a new tag thereon. These tags (13)-(24) can be made of other materials or be in other colors, but it is preferred that they be reflective and made of a durable plastic material and that the adhesive be such that it will permanently attach to a metal key but can be easily removed from a slick backing material on the tag sheet (40).

In FIG. 3, the tags (13) are red and circular. There are two of the tags (13) on the tag sheet, although only one would be needed for this invention. It is preferred, however, that a tag (13) be provided for both sides of the head of a first key (11) so that the key does not need to be turned over in order to identify it. The tags (14) are blue and circular, the tags (15) are orange and circular, the tags (16) are green and circular, the tags (17) are yellow and circular and the tags (19) are purple and circular. Of course it does not matter what color the circular tags (13)-(18) are as long as they can be differentiated from each other. Of course other shapes can be used instead of circles. Additionally, square tags (19), (20), (21), (22), (23) and (24) are provided and are also respectively red, blue, orange, green, yellow and purple as shown.

The labels (25) on FIG. 3 also have adhesive on the back, but can easily be removed from the tag sheet (40), which has a slick and smooth coating to permit the labels (25) to be easily removed therefrom. The label for house #1 has been identified with the reference numeral (25) but all of the other labels below that are identical except that they just have a different object printed thereon for identification purposes. Also, some of these labels could be blank so that someone can put the reference sheet (40) in a typewriter and type the labels thereon or label them with pen and ink.

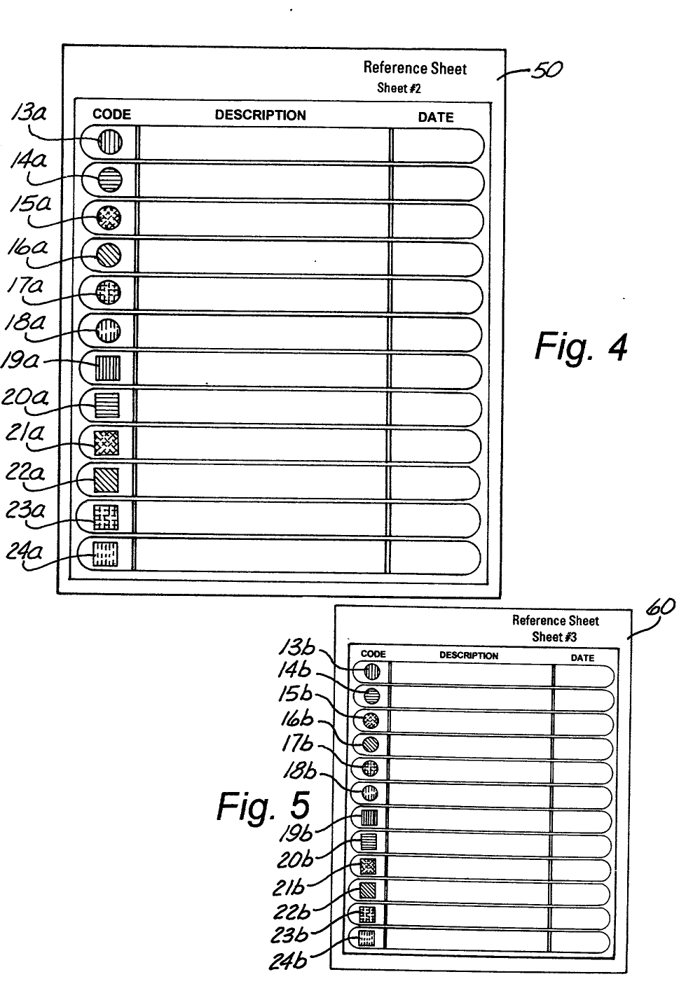

Referring now to FIG. 4, a reference sheet (50) has indicia (13a), (14a), (15a), (16a), (17a), (18a), (19a), (20a), (21a), (22a), (23a) and (24a). These indicia (13a)-(24a) correspond exactly in shape and color to the tags (13)-(24) of FIG. 3. Preferably these indicia (13a)-(24a) are printed on the reference sheet (50), but they could be merely one of the tags (13)-(24) that are placed on the reference sheet if it is desired to construct the reference sheet in this manner. The reference sheet (50) is designed so that when labels (25) are placed under the description column that they will stay there and not be easily removed. Preferably the material of the reference sheet (50) is not a slick material like that of sheet (40), but of a material such as a paper with a more rough surface where an attachment of labels (25) thereto will cause them to be permanently attached to the reference sheet (50).

Reference sheet (60) is merely a miniature reproduction of reference sheet (50) and indicia (13b), (14b), (15b), (16b), (17b), (18b), (19b), (20b), (21b), (22b), (23b) and (24b) are essentially identical in shape and color to the respective indicia (13a)-(24a) except for their size.

To use the apparatus of FIGS. 3-5, a user just needs to follow the instructions on the instruction sheet of FIG. 2, which is included as part of a package. Also included in the package is tag sheet (40), reference sheet (50) and a reference sheet (60).

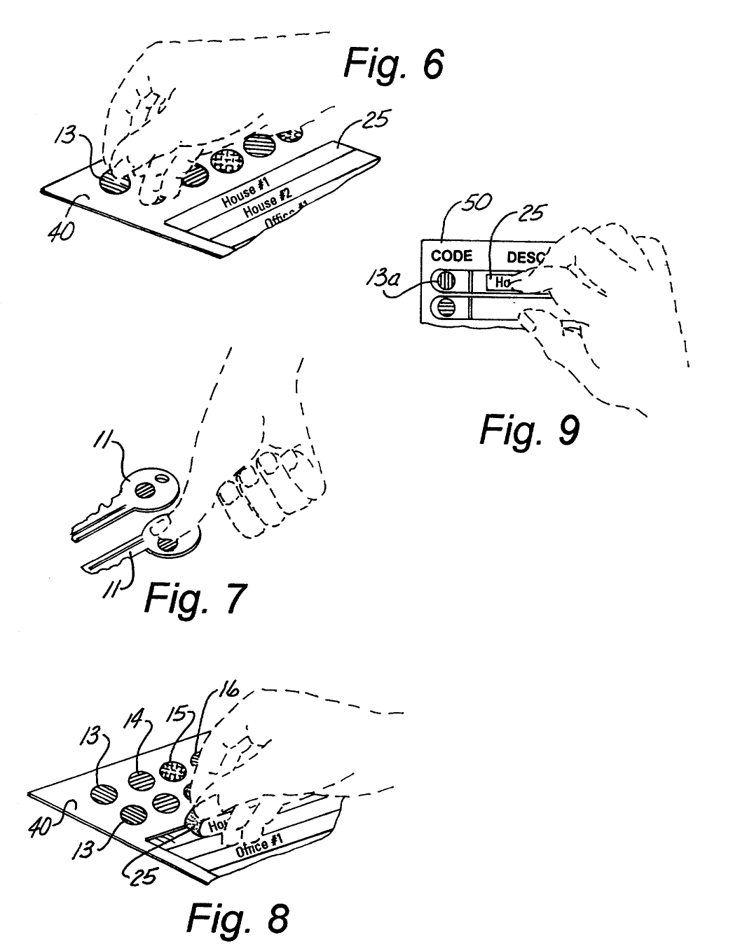

FIG. 6 shows a user removing a red circular tag (13) from the reference sheet (40) and placing it on one side of the head of key (11) after having placed the other red circular tag on the other side of key (11). Since this key (11) corresponds to the lock for house #1, the label (25) from house #1 is placed in the description column of reference sheet (50) beside indicia (13a) which is a circular red dot. After that has been done, the date when this event occurs can be placed on the reference sheet (50) adjacent to label (25) which has house #1 attached thereto.

The FIG. 9 procedure is then also repeated using reference sheet (60) wherein the other house #1 label (25) is placed on reference sheet (60) and adjacent the red circled indicia (13b) and a date is placed in the date column to correspond with when this activity occurred. Having the date thereon is not necessary, but could be useful at times, for example, if someone would move from one house to a second or third house, so that there would be no confusion as to which house was the #1 house. This procedure is then repeated for each and every key that the owner wishes to identify by placing one of the tags (13)-(24) on each side of the key and then placing a corresponding label (25) adjacent to the corresponding indicia (13a)-(24a) on reference sheet (50). Of course for each and every key this procedure is repeated for the reference sheet (60) so that the reference sheet (60) can be placed in a wallet, purse or pocket and the larger reference sheet (50) can be kept is a safe place at the user's home or office, for example. Reference sheet (60) is essentially a smaller duplicate of reference sheet (50).

Consequently, when it is desired to use any key that has a tag on it, one only needs to match the color and shape of the tag to the corresponding indicia on one of the reference sheets (50) or (60) and look at the label beside that corresponding indicia to determine what object can be locked or unlocked with that respective key.

The tags and indicia can be common shapes such as triangles, rectangles, ovals, X's, etc. instead of, or in addition to, the circles and squares that are shown. Other colors or printed patterns(e.g. a plaid design of a specific color or colors) can be used to distinguish the tag in combination with the shape.

Obviously many modifications and variations of the present invention are possible in light of the above teachings. It is therefore to be understood that, within the scope of the appended claims, the invention may be practiced otherwise than as specifically described.

I claim:

1. An apparatus for identifying keys comprising:
a plurality of tags having an adhesive on one side thereof for permitting attachment to a key, said tags being distinguishable from each other by a combination of color and shape; and
a reference sheet having a plurality of indicia thereon, each of said indicia being of a color and shape to match the color and shape of at least some of said tags, said reference sheet having a space beside each respective one of said colored shapes for permitting an identification to be placed in said respective space whereby the respective colored shape can be matched to a respective tag attached to a key for locking or unlocking an object identified in a respective one of said respective spaces on said reference sheet beside said respective indicia.

2. The apparatus of claim 1 wherein said indicia are chosen from a group of shapes including a square and a circle.

3. The apparatus of claim 1 wherein said tags are chosen from a group of shapes including a square and a circle.

4. The apparatus of claim 1 wherein said tags have a reflective material on a top surface thereof.

5. The apparatus of claim 1 having a second reference sheet substantially the same as the first said reference sheet except that it is smaller.

6. The apparatus of claim 1 wherein a place for a date is provided beside each of said spaces on said reference sheet.

7. The apparatus of claim 1 wherein said tags are constructed of a type of material used for renewal stickers on vehicle license plates.

8. An apparatus for identifying keys comprising:
a plurality of tags having an adhesive on one side thereof for permitting attachment to a key, said tags being distinguishable from each other by a combination of color and shape;
a plurality of labels for identifying an object that can be opened with a key, said labels having an adhesive on one side thereof; and
a reference sheet having a plurality of indicia thereon, each of said indicia being of a color and shape to match the color and shape of at least some of said tags, said reference sheet having a space beside each respective one of said colored shapes for permitting attachment of one of said labels thereto whereby the respective colored shape can be matched to a respective tag attached to a key for locking or unlocking an object identified on a respective one of said labels placed on said reference sheet beside said respective indicia.

9. The apparatus of claim 8 wherein said indicia are chosen from a group of shapes including a square and a circle.

10. The apparatus of claim 8 wherein said tags are chosen from a group of shapes including a square and a circle.

11. The apparatus of claim 8 wherein said tags have a reflective material on a top surface thereof.

12. The apparatus of claim 8 having a second reference sheet substantially the same as the first said reference sheet except that it is smaller.

13. The apparatus of claim 8 wherein a place for a date is provided beside each of said spaces on said reference sheet.

14. The apparatus of claim 8 wherein said tags are constructed of a type of material used for renewal stickers on vehicle license plates.

15. A method of using an apparatus for identifying keys of a type comprising: a plurality of tags having an adhesive on one side thereof for permitting attachment to a key, said tags being distinguishable from each other by a combination of color and shape; a plurality of labels for identifying an object that can be opened with a key, said labels having an adhesive on one side thereof; and a reference sheet having a plurality of indicia thereon, each of said indicia being of a color and shape to match the color and shape of at least some of said tags, said reference sheet having a space beside each respective one of said colored shapes for permitting attachment of one of said labels thereto whereby the respective colored shape can be matched to a respective tag attached to a key for locking or unlocking an object identified on a respective one of said labels placed on said reference sheet beside said respective indicia, said method comprising:
placing a first tag on a head of a first key;
selecting a first label which identifies a first object to be opened by said first key; and
placing said first label on the reference sheet adjacent an indicia matching the shape and color of said first tag.

16. The method of claim 15 comprising:
placing a second tag on the head of a second key;
selecting a second label which identifies a second object to be opened by said second key; and
placing said second label on the reference sheet adjacent an indicia matching the shape and color of said second tag.

17. The method of claim 16 comprising:
placing a third tag on the head of a third key;
selecting a third label which identifies a third object to be opened by said third key; and
placing said third label on the reference sheet adjacent an indicia matching the shape and color of said third tag.

18. The method of claim 15 including placing a date on the reference sheet beside the first label.

19. The method of claim 16 including placing a date on the reference sheet beside the second label.

20. The method of claim 17 including placing a date on the reference sheet beside the third label.

21. A method of using an apparatus for identifying keys of a type comprising: a plurality of tags having an adhesive on one side thereof for permitting attachment to a key, said tags being distinguishable from each other by a combination of color and shape; and a reference sheet having a plurality of indicia thereon, each of said indicia being of a color and shape to match the color and shape of at least some of said tags, said reference sheet having a space beside each respective one of said colored shapes for permitting an identification to be placed in said respective space whereby the respective colored shape can be matched to a respective tag attached to a key for locking or unlocking an object identified in a respective one of said respective spaces on said reference sheet beside said respective indicia, said method comprising:
placing a first tag on a head of a first key; and
placing a first name of an object which can be unlocked by using said first key on the reference sheet adjacent an indicia matching the shape and color of said first tag.

22. The method of claim 21 including:
placing a second tag on a head of a second key; and
placing a name of a second object which can be unlocked by using said second key on the reference sheet adjacent an indicia matching the shape and color of said second tag.

23. The method of claim 22 including:
placing a third tag on a head of a third key; and
placing a third name of an object which can be unlocked by using said third key on the reference sheet adjacent an indicia matching the shape and color of said third tag.

24. The method of claim 21 including placing a date on the reference sheet beside the first name.

25. The method of claim 22 including placing a date on the reference sheet beside the second name.

26. The method of claim 23 including placing a date on the reference sheet beside the third name.
